(19) United States
(12) Patent Application Publication
(10) Pub. No.: US 2014/0135996 A1
(43) Pub. Date: May 15, 2014

(54) DIGITAL EXERCISE EQUIPMENT CLUSTER SYSTEM

(71) Applicant: Juntao Yu, Daxing District, (CN)

(72) Inventor: Juntao Yu, Daxing District, (CN)

(73) Assignees: Beijing Meya Virtual Realty Eternal Technology Co., Daxing District, Beijing (CN); Beijing Meya Virtual Reality High-Tech Co., Ltd., Chaoyang District, Beijing (CN); ILODO (Beijing) Sports Technology Co., Ltd., Dongcheng District Beijing (CN)

(21) Appl. No.: 14/234,355

(22) PCT Filed: Aug. 8, 2011
(86) PCT No.: PCT/CN2011/078129

§ 371 Date: Jan. 22, 2014

(30) Foreign Application Priority Data
Jul. 22, 2011 (CN) 201120262647.3

(51) Int. Cl. G05B 15/02

(52) U.S. Cl. CPC G05B 15/02
USPC 700/275

(57) ABSTRACT

A digital exercise equipment cluster system comprises a computation unit, a display unit, stereo equipment, environmental effects equipment and multiple pieces of exercise equipment installed with electronic control equipment. The computation unit is connected to the display unit, stereo equipment and environmental effects equipment, respectively, and is connected to the electronic control equipment on the exercise equipment through interface circuits. The exercise equipment is any one of a dynamic bicycle, a treadmill, an elliptical trainer, an indoor rower. The system may form multiple pieces of exercise equipment into one exercise equipment cluster system capable of general scheduling and independent operations, so as to provide a basic platform for group activities of multiple exercisers.

### CROSS REFERENCE TO RELATED APPLICATION

This application claims the priority of Chinese Patent Application No. 201120262647.3, filed on Jul. 22, 2011 in the SIPO (State Intellectual Property Office of the P.R.C). Further, this application is the National Phase application of International Application No. PCT/CN2011/078129 filed Aug. 8, 2011, which designates the United States and was published in Chinese.

### BACKGROUND

1. Technical Field

The present invention relates to a digital exercise equipment cluster system, and in particular to a digital exercise equipment cluster system formed by multiple pieces of exercise equipment and capable of being used body builders to carry out group activities/games, which belongs to the technical field of exercise equipment.

2. Related Art

Common exercise equipment includes spinning, an exercise bike, a treadmill, an elliptical machine, a rowing machine, and so on. Using the exercise equipment is very beneficial to people's body, but the use process is tedious, not easy to arouse people's interest in long-term exercise.

By taking the spinning (or treadmill, exercise bike, etc.) as an example, the spinning is supposed to let body builders simulate outdoor cycling exercise effects indoors, but the existing spinning room makes body builders cycle facing a trainer, a wall or a mirror, which will inevitably be boring after a long time, and does not have open novelty of outdoor cycling. Meanwhile, racing games played during the training for increasing fun and competitive nature cannot be effectively carried out due to lack of achievement assessment measures. In addition, the bike will automatically change resistance according to a slope in outdoor cycling, but the existing spinning only can manually change the resistance, which lacks sense of reality.

To solve the above problems, a variety of technical solutions have been proposed. For example, Chinese Utility Model Patent with Patent No. ZL 200820132890.1 discloses a spinning training system. The training system uses three-dimensional (3D) technologies to achieve dynamic image display, and uses a single chip microcontroller to perform keyboard lighting control and spinning data acquisition as well as wireless transmission and receiving. The body builders can see beautiful scenic tracks while exercising, and with corresponding music and lighting, they feel they are standing in the tracks, thereby increasing the fun of group aerobic exercise training such as spinning. However, the training system requires that each set of spinning shall be equipped with a computer, and the spinning should be installed with a display in the front thereof. This not only has large investment and takes up more space, but also may not be conductive to group activities because the display blocks the line of sight, and thus it is not suitable for the spinning room that is provided with more spinning, has smaller space, and emphasizes group participation.

Besides, Chinese Invention Patent with Patent No. ZL 200910073829.3 discloses a high-presence intelligent sensing interactive motion system and an implementation method thereof. The system is formed by a motion platform subsystem, a virtual reality subsystem and a projection display subsystem; where the virtual reality subsystem is formed by a motion control computer, a network server computer and a scene rendering computer. The invention provides an immersive virtual reality environment for a motion platform, and the virtual reality environment feeds back control information to the motion platform to achieve interaction between motion and the environment, which increases presence, so that the participants have a high sense of immersion, thereby improving fitness fun, and achieving health benefits. However, the system does not make special designs with respect to characteristics of a variety of exercise equipment such as spinning, treadmills, exercise bikes, and thus the application scope is limited.

### SUMMARY

The technical problem to be solved by the present invention is to provide a digital exercise equipment cluster system. The cluster system can be installed in a spinning room or a treadmill room, so that body builders can carry out group activities/games.

To achieve the above invention objective, the present invention adopts the following technical solution:

A digital exercise equipment cluster system includes a computation unit, a display unit and multiple pieces of exercise equipment installed with electronic control equipment; and

the computation unit is connected with the display unit, and is connected with the electronic control equipment on each set of exercise equipment by using an interface circuit.

Preferably, the electronic control equipment includes a motion detection unit, a data transmission unit and a power supply unit; where the motion detection unit is connected with the data transmission unit and the power supply unit, and the data transmission unit is connected with the computation unit by using the interface circuit.

Preferably, the power supply unit is any one of a battery, a transformer and a self-powered module.

Preferably, the self-powered module includes a friction wheel, a generator, and a storage battery; where the friction wheel contacts a rotating wheel on the exercise equipment, and the rotating wheel drives the friction wheel to rotate, so as to drive the generator to rotate to generate electricity.

Preferably, the exercise equipment is any one of spinning, an exercise bike, a treadmill, an elliptical machine, and a rowing machine.

When the exercise equipment is spinning, the electronic control equipment further includes an automatic resistance adjusting unit, and the automatic resistance adjusting unit is connected with the data transmission unit.

When the exercise equipment is a treadmill, the electronic control equipment further includes an automatic slope adjusting unit, and the automatic slope adjusting unit is connected with the data transmission unit.

Preferably, the digital exercise equipment cluster system further includes stereo equipment, and the stereo equipment is connected with the computation unit.

Preferably, the digital exercise equipment cluster system further includes environmental effects equipment, and the environmental effects equipment is connected with the computation unit.

Preferably, the display unit is a projector or a large-screen display.

According to the present invention, multiple pieces of exercise equipment can form a digital exercise equipment cluster system that can perform unified scheduling and can also operate individually, so as to provide a basic platform for a number of body builders in a spinning room or a treadmill room to carry out group activities/games.

### BRIEF DESCRIPTION OF THE DRAWINGS

The present invention is further described below in detail with reference to the accompanying drawings and specific embodiments.

FIG. 1 is a schematic overall structural view of a exercise equipment cluster system implemented based on spinning in a first embodiment of the digital exercise equipment cluster system; and

FIG. 2 is a schematic overall structural view of a exercise equipment cluster system implemented based on a treadmill in a second embodiment of the digital exercise equipment cluster system.

### DETAILED DESCRIPTION

The exercise equipment in the present invention includes spinning, an exercise bike, a treadmill, an elliptical machine, a rowing machine, and so on. The digital exercise equipment cluster system in the present invention is described below in detail specifically by taking spinning and a treadmill as examples.

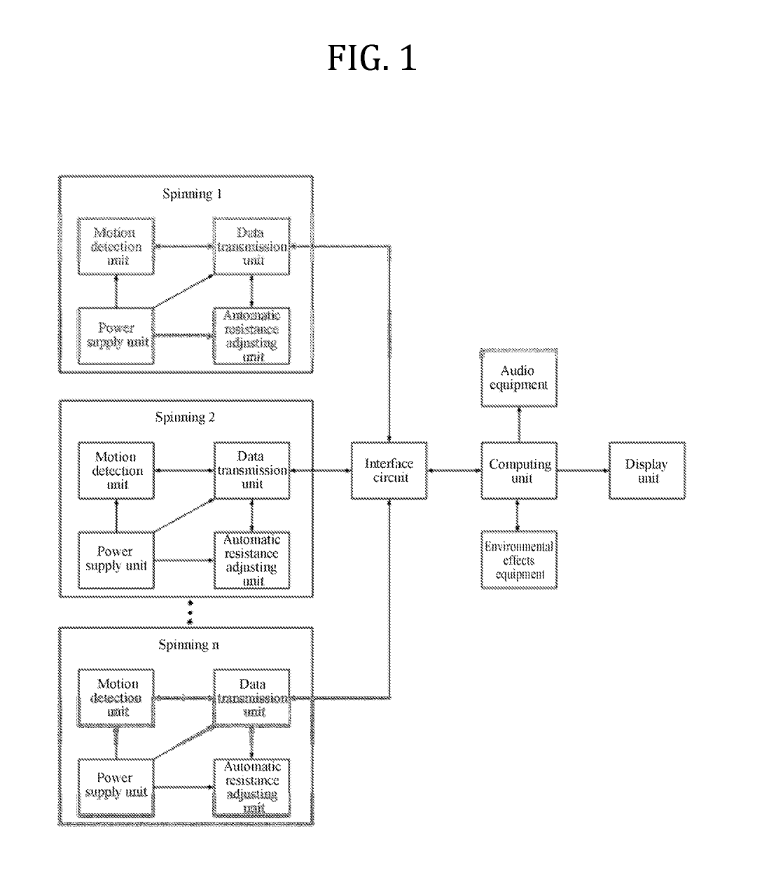

FIG. 1 shows an overall structure of a spinning cluster system as a first embodiment of the present invention. Spinning is a new indoors cycling way in combination with music, lighting and the like. Its structure is similar to that of an ordinary bicycle, including several parts such as handlebars, a seat, pedal boards, and wheels, and the body is firmly linked into a whole. In spinning classes, a trainer can adjust resistance and revolution of a bicycle according to individual efforts, simulate uphill, downhill and walking-in-place actions, and can also play racing games. With music and lighting, body builders can simulate various sports, such as mountain climbing and fast riding.

As shown in FIG. 1, the spinning cluster system includes a computation unit, a display unit, stereo equipment, environmental effects equipment and n (n is a natural number) spinning installed with electronic control equipment. The computation unit is connected with the display unit, the stereo equipment and the environmental effects equipment, and is connected with the electronic control equipment on each set of spinning by using an interface circuit. The electronic control equipment installed on the spinning includes a motion detection unit, a data transmission unit, a power supply unit, an automatic resistance adjusting unit and the like. The motion detection unit is connected with the data transmission unit and the power supply unit. The power supply unit is simultaneously connected with the motion detection unit, the data transmission unit and the automatic resistance adjusting unit, to supply power to them. The automatic resistance adjusting unit is connected with the data transmission unit, and the data transmission unit exchanges data with the computation unit by using an interface circuit. The interface circuit can use wired connection manners such as an RS-485 bus, and can also use wireless connection manners such as Bluetooth and wireless local area network (WLAN).

In the spinning cluster system, the computation unit can be implemented by using hardware equipment such as a personal computer (PC) machine, a server or a high-performance single chip microcontroller. The computation unit is responsible for interacting with all spinning in the whole spinning cluster system. Specially designed game software can be run in the computation unit. The game software not only can control generation of game images on a projection screen of the display unit, but also can control, according to user requirements, the stereo equipment to play a variety of background music.

The display unit may be one or more projectors, and may also be a large-screen display. A plurality of projectors may implement cylindrical screen projection or 3D stereo projection. If the display unit uses the projector, there are four implementation manners: the first one is ordinary flat screen projection; the second one is to form a curved screen by using several projectors and an edge blending system, and the implementation manner is more immersive than the flat screen projection; the third one is a 3D stereo projection screen, and in this implementation manner, body builders can experience more powerful 3D effects by wearing 3D glasses; and the fourth one is to combine the curved screen with the 3D stereo projection to form a 3D stereo projection cylindrical screen, and the display effect in the implementation manner is most vivid and powerful.

The environmental effects equipment in the spinning cluster system may include a thunder and lightning simulator, a wind simulator, a snow simulator, an atomized-water sprayer, a bubble effects simulator, a smoke effects simulator, and so on. They function to produce environmental effects during a game such as blowing air, spraying water, spraying atomized water, spraying fragrance, snowing and lighting, to better heighten the atmosphere. For example, when lightning and raining appear in game images displayed by the display unit, the environmental effects equipment may automatically play the sound of thunder by using the stereo equipment, start the thunder and lightning simulator, and meanwhile spray water droplets from the ceiling, achieving a very vivid effect.

The electronic control equipment installed on the spinning at least includes a motion detection unit and a data transmission unit, and may also include a power supply unit, an automatic resistance adjusting unit, and so on. Each set of spinning needs to be installed with a complete set of electronic control equipment, and all electronic control equipment performs data exchange with the computation unit in the spinning cluster system.

In the spinning cluster system, the motion detection unit utilizes a speed sensor such as a Hall switch to detect a cycling or running speed, and a cycling or running direction can also be obtained by detecting a direction button or a game steering wheel. In addition, the spinning can also be provided with a sensor to detect data such as a person's blood pressure and pulse, to lay the foundation for scientific adjustment of exercise intensity.

The data transmission unit sends in real time the data detected by the motion detection unit to the computation unit in a wired transmission or wireless transmission manner, and is also responsible for receiving data or an instruction sent from the computation unit. For each set of spinning, the data transmission unit may additionally transmit an identification (ID) number of the spinning while transmitting data, so that the computation unit could identify the spinning from which the received data is sent.

The power supply unit is used for supplying power to the electronic control equipment on the spinning. The power supply unit may be implemented by using a battery or a transformer, and may also be implemented by using a self-powered module. The self-powered module includes a friction wheel, a generator, a storage battery, and so on. The friction wheel contacts a rotating wheel on the spinning, and when a body builder exercises, the rotating wheel drives the friction wheel to rotate, so as to drive the generator to rotate to generate electricity. The electricity generated by the generator directly drives the electronic control equipment, and excess electricity is stored by the storage battery. As a result, it is unnecessary to frequently replace batteries or install cables for the electronic control equipment on the spinning, resulting in more convenience.

The automatic resistance adjusting unit is used for dynamically adjusting the value of motion resistance of the spinning. In the course of using spinning for exercise, it is often required to adjust motion resistance of the spinning, to facilitate simulation of various sports, such as cycling uphill or downhill. In terms of electromagnetically controlled spinning, the value of the motion resistance thereof can be controlled by adjusting a distance between a magnet and a rotating wheel with a pull motor. When a virtual scene displayed by the display unit is uphill or downhill, the computation unit may transmit current slope data to the automatic resistance adjusting unit, and the automatic resistance adjusting unit controls the pull motor to make corresponding actions, to adjust the distance between the magnet and the rotating wheel, thereby simulating the value of the resistance in the case of a corresponding slope. In this way, the body builder does not need to manually adjust the value of the motion resistance, instead, the computation unit notifies, according to the slope data in the virtual scene, the automatic resistance adjusting unit to automatically adjust the motion resistance of the spinning. The body builder can experience the feeling of outdoor exercise more vividly indoors.

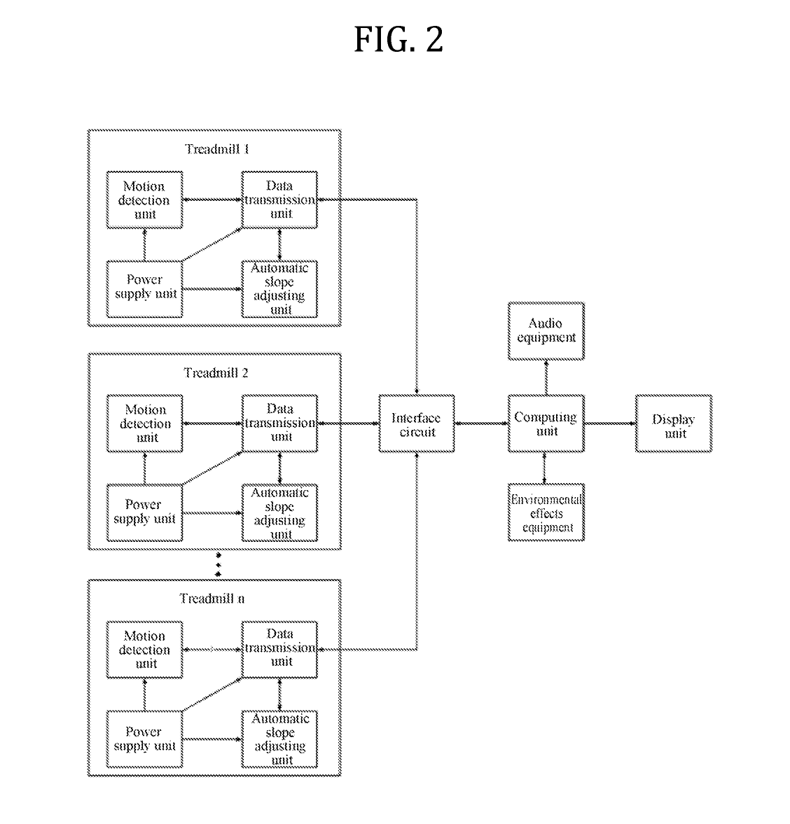

FIG. 2 shows an overall structure of a treadmill cluster system as a second embodiment of the present invention. As shown in FIG. 2, the treadmill cluster system also includes a computation unit, a display unit, stereo equipment, environmental effects equipment and n (n is a natural number) treadmills installed with electronic control equipment. The computation unit is connected with the display unit, the stereo equipment and the environmental effects equipment, and is connected with the electronic control equipment on each treadmill by using an interface circuit. The electronic control equipment installed on the treadmill includes a motion detection unit, a data transmission unit, a power supply unit, an automatic slope adjusting unit and the like. The motion detection unit is connected with the data transmission unit and the power supply unit. The power supply unit is simultaneously connected with the motion detection unit, the data transmission unit and the automatic slope adjusting unit, to supply power to them. The automatic slope adjusting unit is connected with the data transmission unit, and the data transmission unit exchanges data with the computation unit by using the interface circuit.

In the treadmill cluster system, the computation unit, the display unit, the stereo equipment and the environmental effects equipment used are identical with those in the spinning cluster system, which are not detailed herein. Their difference mainly lies in that the electronic control equipment is slightly different. For the spinning cluster system, the electronic control equipment uses an automatic resistance adjusting unit; and for the treadmill cluster system, the electronic control equipment uses an automatic slope adjusting unit.

The automatic slope adjusting unit is used for adjusting the value of an inclination angle of a table, so as to achieve different motion slopes. In terms of a treadmill, the inclination angle of the table can be directly adjusted by a motor, and thus an automatic slope adjusting unit can be directly installed. When a virtual scene displayed by the display unit is uphill or downhill, the computation unit may transmit current slope data to the automatic slope adjusting unit, and the automatic slope adjusting unit sends a control instruction to the motor, to adjust the inclination angle of the table, so that the body builder can feel change of the slope without manual operation, and experience the feeling of outdoor exercise more vividly indoors.

The working principle and process of the digital exercise equipment cluster system are further introduced below. Compared with the exercise equipment individually used in the existing spinning room or treadmill room, the prominent feature of the digital exercise equipment cluster system lies in that, only through cooperation of the computation unit, the display unit and the electronic control equipment on multiple pieces of exercise equipment, the multiple pieces of exercise equipment originally individually installed and individually used form a exercise equipment cluster system that can perform unified scheduling and can also make each set of spinning operate individually, so as to provide a hardware basis for a number of body builders in spinning room or a treadmill room to carry out group activities/games.

As stated above, specially designed game software can be run in the computation unit. The game scene may include a 3D virtual scene and an actually shot scene. Body builders can interact with the game software by using the electronic control equipment installed on the exercise equipment. For example, after game software is started, a game scene is projected on a projection screen by using a projector in the display unit. When a body builder exercises on exercise equipment, a cycling or running speed is transmitted to the computer by using an electronic detection unit, and the body builder can control the cycling or running speed of a virtual character in a game, and can compete with other virtual characters in the game, which reflects desirable fun and interactivity. A number of body builders can enjoy in front of the projection screen vivid outdoor scenic images on a projection screen while exercising or competing. The cycling or running speed of each body builder is detected by the motion detection unit, and then is transmitted to the computation unit by using the data transmission unit. The game software in the computation unit receives, by using an interface circuit, the data transmitted from all exercise equipment in the digital exercise equipment cluster system, and controls the cycling speed of a virtual character corresponding to a real cyclist. Each body builder can separately control the cycling speed of the virtual character corresponding thereto on the projection screen. As a result, the body builders not only can enjoy vivid outdoor scenic images and can also play realistic racing games, but also can make related statistics and analysis on competition results.

In the course of a game, the computation unit can automatically control rhythm and volume of music, and can also indirectly control flicker and brightness of lights in the spinning room or the treadmill room, thereby effectively heightening the atmosphere of the game.

It should be noted that, the above embodiments are mainly described by taking spinning or a treadmill as examples. The application scope of the present invention is not limited to the spinning or treadmill. A similar digital exercise equipment cluster system can also be implemented by installing the electronic control equipment on other exercise equipment such as an exercise bike, an elliptical machine or a rowing machine in combination with a computation unit, a display unit, stereo equipment, environmental effects equipment and the like.

The above describes in detail the digital exercise equipment cluster system provided in the present invention. For persons of ordinary skill in the art, any apparent variation made to it without departing from the spirit of the present invention will constitute an infringement upon the patent right of the present invention, and should bear the corresponding legal responsibility.

What is claimed is:

1. A digital exercise equipment cluster system, characterized in that:
the digital exercise equipment cluster system comprises a computation unit, a display unit, stereo equipment, environmental effects equipment and multiple pieces of exercise equipment installed with electronic control equipment; the display unit is a projector or a large-screen display;
the computation unit is connected with the display unit, and is connected with the electronic control equipment on each set of exercise equipment by using an interface circuit;
the stereo equipment and the environmental effects equipment are separately connected with the computation unit;
the electronic control equipment comprises a motion detection unit, a data transmission unit and a power supply unit; wherein the motion detection unit is connected with the data transmission unit and the power supply unit, and the data transmission unit is connected with the computation unit by using the interface circuit;
the power supply unit is any one of a battery, a transformer and a self-powered module; wherein the self-powered module comprises a friction wheel, a generator, and a storage battery; the friction wheel contacts a rotating wheel on the exercise equipment, and the rotating wheel drives the friction wheel to rotate, so as to drive the generator to rotate to generate electricity; and
the exercise equipment is any one of spinning, an exercise bike, a treadmill, an elliptical machine, and a rowing machine.

2. The digital exercise equipment cluster system according to claim 1, characterized in that:
when the exercise equipment is spinning, the electronic control equipment further comprises an automatic resistance adjusting unit, and the automatic resistance adjusting unit is connected with the data transmission unit.

3. The digital exercise equipment cluster system according to claim 1, characterized in that:
when the exercise equipment is a treadmill, the electronic control equipment further comprises an automatic slope adjusting unit, and the automatic slope adjusting unit is connected with the data transmission unit.

4. A digital exercise equipment cluster system, characterized in that:
the digital exercise equipment cluster system comprises a computation unit, a display unit and multiple pieces of exercise equipment installed with electronic control equipment; and
the computation unit is connected with the display unit, and is connected with the electronic control equipment on each set of exercise equipment by using an interface circuit.

5. The digital exercise equipment cluster system according to claim 4, characterized in that:
the electronic control equipment comprises a motion detection unit, a data transmission unit and a power supply unit; wherein the motion detection unit is connected with the data transmission unit and the power supply unit, and the data transmission unit is connected with the computation unit by using the interface circuit.

6. The digital exercise equipment cluster system according to claim 5, characterized in that:
the power supply unit is any one of a battery, a transformer and a self-powered module.

7. The digital exercise equipment cluster system according to claim 6, characterized in that:
the self-powered module comprises a friction wheel, a generator, and a storage battery;
wherein the friction wheel contacts a rotating wheel on the exercise equipment, and the rotating wheel drives the friction wheel to rotate, so as to drive the generator to rotate to generate electricity.

8. The digital exercise equipment cluster system according to claim 4, characterized in that:
the exercise equipment is any one of spinning, an exercise bike, a treadmill, an elliptical machine, and a rowing machine.

9. The digital exercise equipment cluster system according to claim 8, characterized in that:
when the exercise equipment is spinning, the electronic control equipment further comprises an automatic resistance adjusting unit, and the automatic resistance adjusting unit is connected with the data transmission unit.

10. The digital exercise equipment cluster system according to claim 8, characterized in that:
when the exercise equipment is a treadmill, the electronic control equipment further comprises an automatic slope adjusting unit, and the automatic slope adjusting unit is connected with the data transmission unit.

11. The digital exercise equipment cluster system according to claim 4, characterized in that:
the digital exercise equipment cluster system further comprises stereo equipment, and the stereo equipment is connected with the computation unit.

12. The digital exercise equipment cluster system according to claim 4, characterized in that:
the digital exercise equipment cluster system further comprises environmental effects equipment, and the environmental effects equipment is connected with the computation unit.

13. The digital exercise equipment cluster system according to claim 4, characterized in that:
the display unit is a projector or a large-screen display.
